(19) United States
(12) Patent Application Publication
(10) Pub. No.: US 2014/0300606 A1
(43) Pub. Date: Oct. 9, 2014

(54) DRAWING DEVICE, DRAWING METHOD, AND DRAWING PROGRAM

(71) Applicant: Funai Electric Co., Ltd., Osaka (JP)

(72) Inventor: Takeshi NAKADA, Daito-shi (JP)

(73) Assignee: Funai Electric Co., Ltd., Osaka (JP)

(21) Appl. No.: 14/230,248

(22) Filed: Mar. 31, 2014

(30) Foreign Application Priority Data
Apr. 8, 2013 (JP) 2013-080530

(51) Int. Cl. G06T 11/20

(52) U.S. Cl. CPC G06T 11/203
USPC 345/441

(57) ABSTRACT

A drawing device includes an input unit, a first vector calculation unit, a second vector calculation unit, and a display control unit. The input unit accepts user input. The first vector calculation unit calculates a first vector whose starting point is one of the endpoints of a hand-drawn line displayed on a display unit based on the user input. The second vector calculation unit calculates a second vector whose starting point is the one endpoint based on the shape of the hand-drawn line in the vicinity of the one endpoint. The display control unit determines whether to extend the hand-drawn line or to erase at least a portion of the hand-drawn line with the one endpoint as the starting point based on the first and second vectors and also performs the extension or at least partial erasure of the hand-drawn line based on the user input.

### BACKGROUND OF THE INVENTION

1. Field of the Invention

The present invention relates to a drawing device, a drawing method, and a drawing program.

2. Description of the Related Art

Graphical drawing systems which can draw and edit graphics, such as CAD systems, have been known in the past. Such graphical drawing systems use approximation curves such as Bezier curves to allow drawing of lines freehand. Manipulating various control points of Bezier curves to alter existing freehand lines is a known method for editing the freehand lines that have been drawn. For example, when it is desired to further extend a freehand line, individual control points that are input with single mouse clicks are linked using a Bezier curve in Japanese Patent Application Laid-Open Publication No. 2000-187736.

Another known method is to temporarily erase the freehand line itself when editing a freehand line that has been drawn and then to redraw it.

With conventional drawing systems, however, when a freehand line is to be extended or partially erased, it is necessary to separately select a mode that extends freehand lines or a mode that erases freehand lines. Therefore, there is a problem in that editing freehand lines becomes troublesome. Japanese Patent Application Laid-Open Publication No. 2000-187736 mentions absolutely nothing about a countermeasure for such a problem.

### SUMMARY OF THE INVENTION

In light of such circumstances, preferred embodiments of the present invention provide a drawing device, a drawing method, and a drawing program which are capable of extending hand-drawn lines and erasing at least a portion of hand-drawn lines more intuitively and simply.

A drawing device according to one aspect of a preferred embodiment of the present invention includes an input unit configured to accept user input; a first vector calculation unit configured to calculate a first vector whose starting point is one of the endpoints of a hand-drawn line displayed on a display unit based on the user input; a second vector calculation unit configured to calculate a second vector whose starting point is the one endpoint based on the shape of the hand-drawn line in the vicinity of the one endpoint; and a display control unit configured to determine whether to extend the hand-drawn line or to erase at least a portion of the hand-drawn line with the one endpoint as the starting point based on the first and second vectors and configured to perform the extension or at least partial erasure of the hand-drawn line based on the user input.

With such a configuration, whether to extend the hand-drawn line or to erase at least a portion thereof with one of the endpoints of the hand-drawn line as the starting point is determined based on a first vector that is based on user input and a second vector that is based on the shape of the hand-drawn line in the vicinity of the one endpoint. Furthermore, the hand-drawn line is extended or at least partially erased based on the user input at the time of the calculation of the first vector. Because of this, when the hand-drawn line is to be extended or at least partially erased, there is no need for any new user input in order to select one of these two actions. Accordingly, even if there is a drawing error such as a gap or jump in the line while drawing a hand-drawn line, for example, the hand-drawn line is extended or at least partially erased more intuitively and simply.

Preferably, the display control unit is configured to extend the hand-drawn line if the angle defined by the first and second vectors exceeds a predetermined threshold, and to erase at least a portion of the hand-drawn line if the angle defined by the first and second vectors is equal to or less than the threshold.

Thus, the hand-drawn line is preferably extended if the direction of the first vector differs from the direction of the second vector by more than the predetermined threshold. On the other hand, if the direction of the first vector is the same as the direction of the second vector within the tolerance of the threshold, then at least a portion of the hand-drawn line preferably is erased.

An auxiliary display control unit may preferably further be provided and configured to display, on the display unit, an auxiliary display that indicates the vector direction for extending or erasing at least a portion of the hand-drawn line with the one endpoint as the starting point.

With this constitution, the vector direction for extending or erasing at least a portion of the hand-drawn line preferably is visually presented to the user.

A drawing method according to another preferred embodiment of the present invention includes a step of calculating a first vector including a starting point that is one of the endpoints of a hand-drawn line displayed on a display unit based on user input; a step of calculating a second vector including a starting point that is the one endpoint based on the shape of the hand-drawn line in the vicinity of the one endpoint; a step of determining whether to extend the hand-drawn line or to erase at least a portion of the hand-drawn line with the one endpoint as the starting point based on the first and second vectors; and a step of performing the extension or at least partial erasure of the hand-drawn line based on the user input.

With such a method, whether to extend the hand-drawn line or to erase at least a portion of the hand-drawn line with one of the endpoints of the hand-drawn line as the starting point is determined based on a first vector that is based on user input and a second vector that is based on the shape of the hand-drawn line in the vicinity of the one endpoint. Furthermore, the hand-drawn line is extended or at least partially erased based on the user input when the first vector is calculated. Therefore, when the hand-drawn line is to be extended or at least partially erased, it is not necessary to have any new user input in order to select one of these two actions. Consequently, even if there is a drawing error such as a gap or jump in the line while drawing a hand-drawn line, for example, it is possible to more intuitively and simply extend or at least partially erase the hand-drawn line.

Moreover, according to a further preferred embodiment of the present invention, a non-transitory computer-readable medium including a computer drawing program executes, when the program runs on a computer, a method including a step of calculating a first vector including a starting point that is one of the endpoints of a hand-drawn line displayed on a display unit based on user input; a step of calculating a second vector including a starting point that is the one endpoint based on the shape of the hand-drawn line in the vicinity of the one endpoint; a step of determining whether to extend the hand-drawn line or to erase at least a portion of the hand-drawn line with the one endpoint as the starting point based on the first and second vectors; and a step of performing the extension or at least partial erasure of the hand-drawn line based on the user input.

With such a program, whether to extend the hand-drawn line or to erase at least a portion of the hand-drawn line with one of the endpoints of the hand-drawn line as the starting point is determined on the basis of a first vector that is based on user input and a second vector that is based on the shape of the hand-drawn line in the vicinity of the one endpoint. In addition, the hand-drawn line is extended or at least partially erased based on the user input at the time of the calculation of the first vector. For this reason, when the hand-drawn line is to be extended or at least partially erased, no new user input is required in order to select one of these two actions. Accordingly, even if there is a drawing error such as a gap or jump in the line while drawing a hand-drawn line, for example, the hand-drawn line is extended or at least partially erased more intuitively and simply.

With various preferred embodiments of the present invention, it is possible to provide a drawing device, a drawing method, and a drawing program that extend hand-drawn lines and erase at least a portion of hand-drawn lines more intuitively and simply.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of the external appearance of a tablet terminal.

FIG. 2 is a block diagram showing the internal configuration of the tablet terminal according to a first preferred embodiment of the present invention.

FIG. 3 is a flowchart for describing a method for extending or partially erasing a freehand line.

FIG. 4A is a display screen of a freehand line that has been drawn.

FIG. 4B is a display screen when the freehand line is selected in the first preferred embodiment of the present invention.

FIG. 4C is a display screen when an indicator is selected in the first preferred embodiment of the present invention.

FIG. 4D is a display screen when the freehand line is partially erased.

FIG. 4E is a display screen when the freehand line is extended.

FIG. 5 is a diagram for illustrating one example of a method for finding line vectors in the vicinity of the starting point of a freehand line.

FIG. 6A is a diagram showing one example of a freehand line that has been drawn in a complex manner.

FIG. 6B is a display screen when the freehand line is selected in a second preferred embodiment of the present invention.

FIG. 7 is a block diagram showing the internal configuration of the tablet terminal 1 according to the second preferred embodiment of the present invention.

FIG. 8 is a display screen when an indicator is selected in a third preferred embodiment of the present invention.

FIG. 9 is a diagram showing another display example of indicators.

FIG. 10 is a diagram showing another display example of guide displays.

### DETAILED DESCRIPTION OF THE PREFERRED EMBODIMENTS

Preferred embodiments of the present invention will be described below with a tablet terminal being used as an example with reference to drawings.

### First Preferred Embodiment

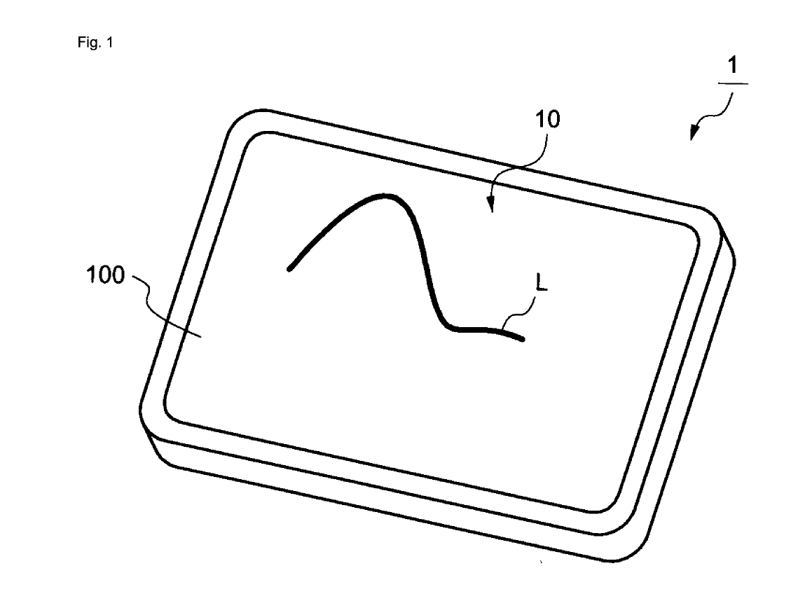

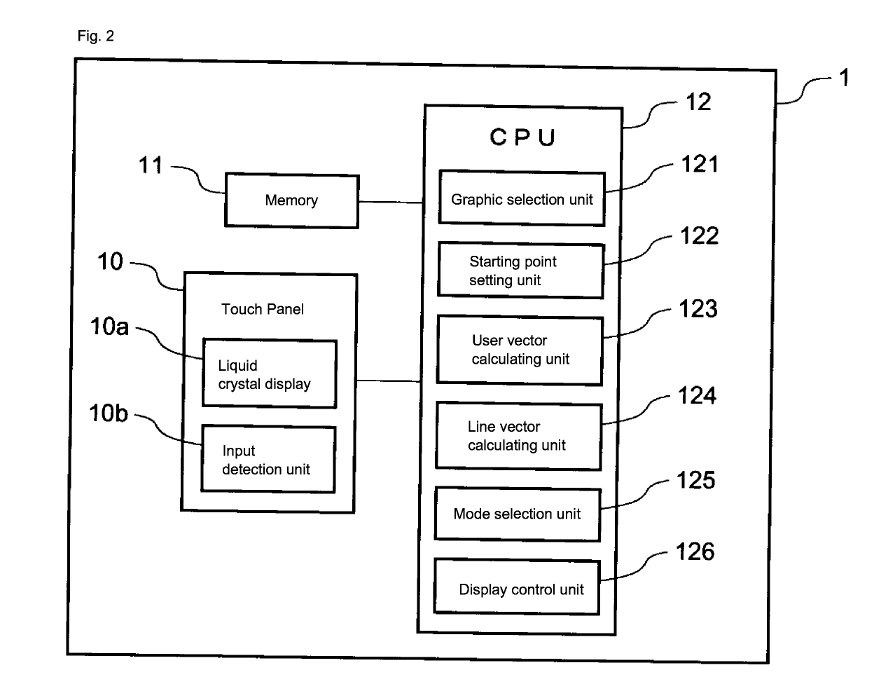

FIG. 1 is a perspective view of the external appearance of a tablet terminal. FIG. 2 is a block diagram showing the internal configuration of the tablet terminal. The tablet terminal 1 preferably includes a touch panel 10, memory 11, and a CPU 12 as shown in FIGS. 1 and 2. In addition to these elements, the tablet terminal 1 may also include an audio output unit such as a speaker that outputs audio based on audio output signals that are output from the CPU 12.

The touch panel 10 is a display input unit that is configured to accept input when the user touches the display screen 100 with an object U such as a finger or a stylus. This touch panel 10 preferably includes a liquid crystal display 10a and an input detection unit 10b. The liquid crystal display 10a is a display unit which bases its display on control signals, video signals, and the like that are output from the CPU 12. The input detection unit 10b is an input unit which detects input operations via touch input based on the behavior of the object U (which may be the user's finger, a stylus, or the like, for example) that touches the display screen 100 of the touch panel 10. This touch input is one example of the user input. For example, when the user's finger U touches the display screen 100 of the touch panel 10, the input detection unit 10b senses the contact position of the finger U on the display screen 100. Furthermore, when the user's finger U moves (traces) over the display screen 100 while still touching the display screen 100, the input detection unit 10b senses the contact position on the display screen 100, which indicates the path that the finger U has traced.

The memory 11 preferably is a nonvolatile storage medium and is configured to store the display information of the touch panel 10 and the programs, control information, and the like used by the various components (such as the CPU 12) of the tablet terminal 1. These programs include drawing programs that are executable on a computer or processor to perform the processes to be described later to extend or partially erase a freehand line L. Moreover, the control information includes information that indicates first and second thresholds W1 and W2, information that indicates first and second angle thresholds θa and θb, and the like to be described later.

The CPU 12 is a control unit that is programmed to control various components of the tablet terminal 1. The CPU 12 uses the programs, control information, and the like stored in the memory 11 to perform a variety of functions. For instance, the functional elements of the CPU 12 are programmed and configured so as to include a graphic selection unit 121, a starting point setting unit 122, a user vector calculating unit 123, a line vector calculating unit 124, a mode selection unit 125, and a display control unit 126.

The graphic selection unit 121 is configured to select the graphic specified by touch input from among the graphics displayed on the display screen 100 of the touch panel 10. For example, when the freehand line L displayed on the touch panel 10 is specified by touch input, the graphic selection unit 121 selects this freehand line L as the object on which graphical editing will be run.

The starting point setting unit 122 is configured to set, based on touch input that specifies one of the endpoints EP1 and EP2 of the freehand line L, the endpoint EP1 or EP2 as the starting point P0 for editing (extending or erasing at least partially).

The user vector calculating unit 123 is a first vector calculating unit that is configured to calculate a user vector based on the path of the touch input traced on the touch panel 10. This user vector is a first vector whose starting point P0 is either the endpoint EP1 or endpoint EP2 of the freehand line L specified by touch input, and it indicates the movement direction of the touch input.

The line vector calculating unit 124 is a second vector calculating unit that is configured to calculate a line vector based on the shape of the freehand line L in the vicinity of each of the endpoints EP1 and EP2. This line vector is a second vector whose starting point P0 is each of the endpoints EP1 and EP2 of the freehand line L specified by touch input, and it indicates the drawing direction of the freehand line L in the vicinity of each of the endpoints EP1 and EP2.

The mode selection unit 125 is configured to select either Extend mode or Partial Erasure mode based on, for example, user vectors, line vectors, and the like, and sets the mode as the editing mode for the freehand line L. Extend mode is an editing mode used to extend the freehand line L from the starting point P0 based on the path of the touch input. In Extend mode, a line having the shape and length indicated by the path of the touch input that traces across the touch panel 10 is extended from the starting point P0 (e.g., either the endpoint EP1 or endpoint EP2 of the freehand line L) and displayed. In addition, Partial Erasure mode is an editing mode used to erase the display of at least a portion of the freehand line L based on the path of the touch input. In Partial Erasure mode, display of the portion of the freehand line L equal to the length of the touch input path traced over the touch panel 10 along the freehand line L from the starting point P0 is erased. Note that in Partial Erasure mode, if the length of the path of touch input that traces across the touch panel 10 equals the total length of the freehand line L, then all of the freehand line L is erased.

The display control unit 126 is configured and programmed to control the touch panel 10 (and particularly the display on the liquid crystal display 10a). In particular, the display control unit 126 is configured and programmed to display an image on the liquid crystal display 10a based on the touch input detected by the input detection unit 10b of the touch panel 10. For example, the display control unit 126 determines, based on the user vector and line vector, whether to extend or to erase at least a portion of the freehand line L with one of the endpoints EP1 and EP2 being taken as the starting point P0. Furthermore, the display control unit 126 extends or erases at least a portion of the freehand line L based on the path of touch input tracing over the touch panel 10.

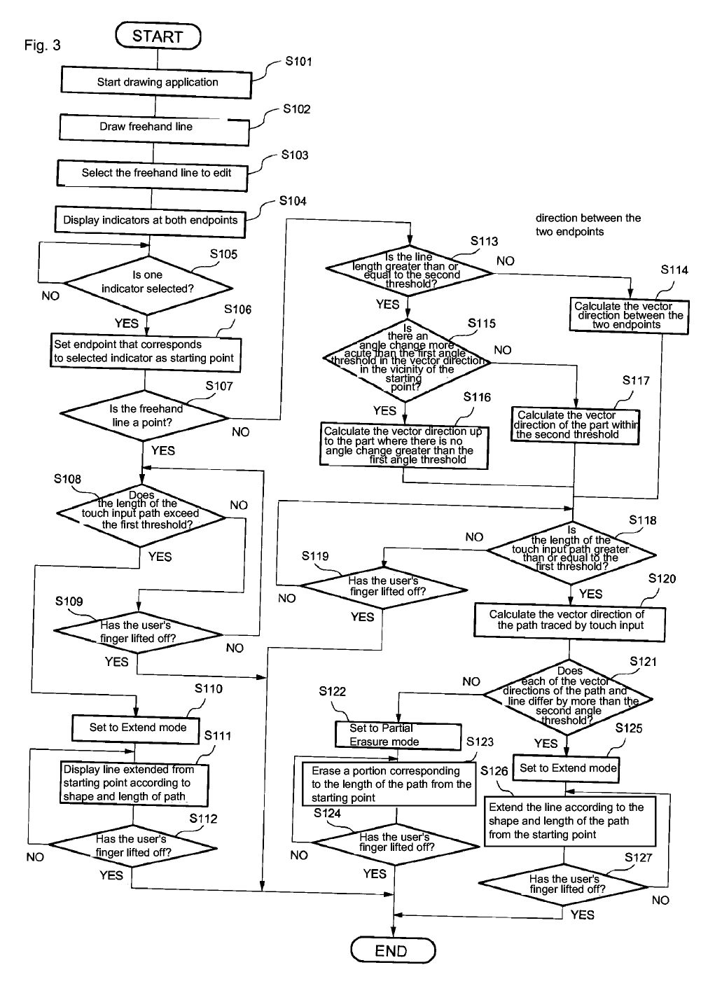

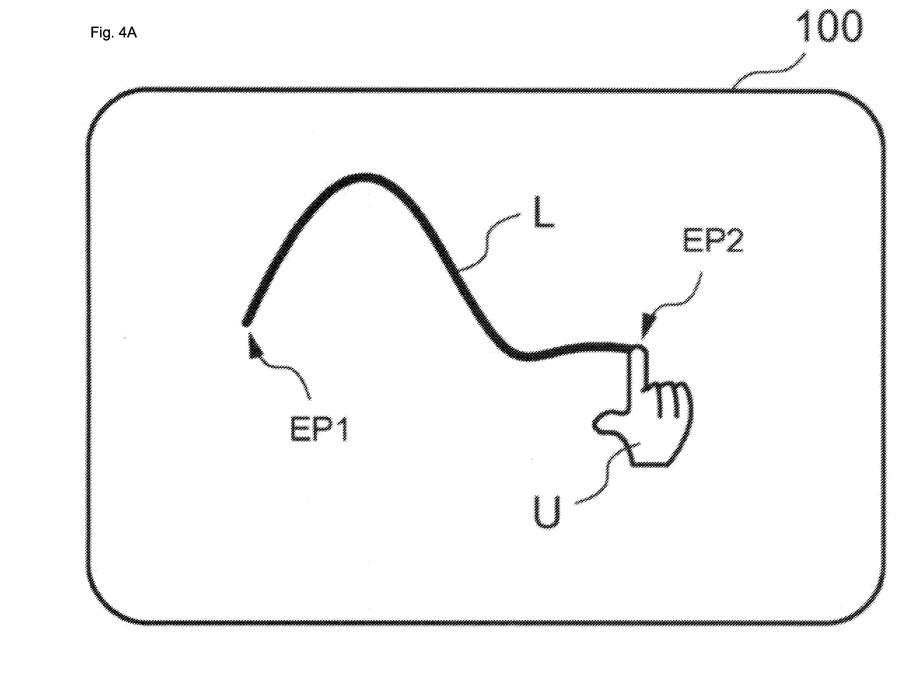

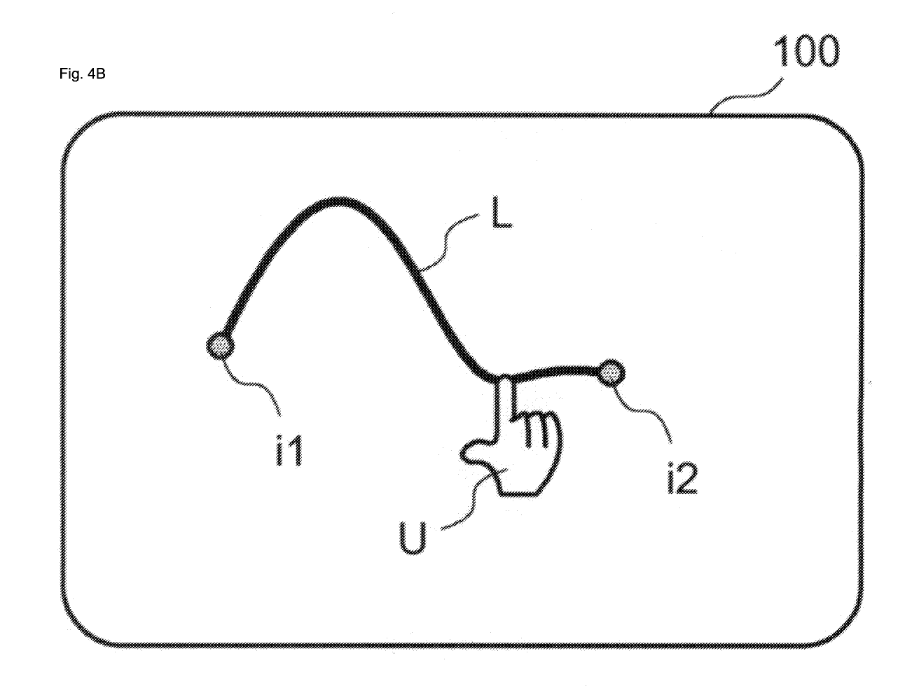

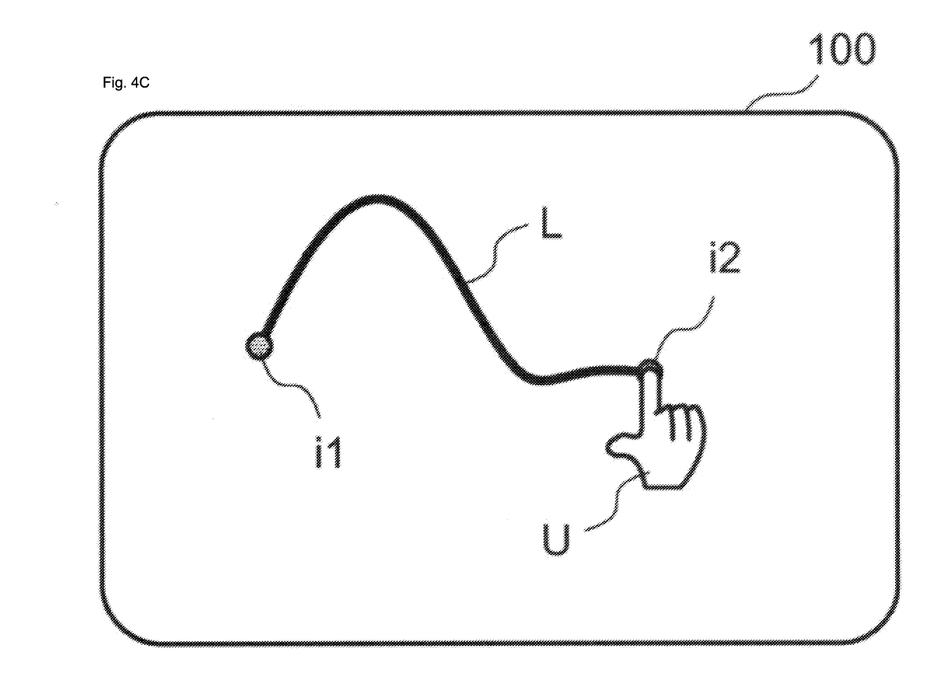

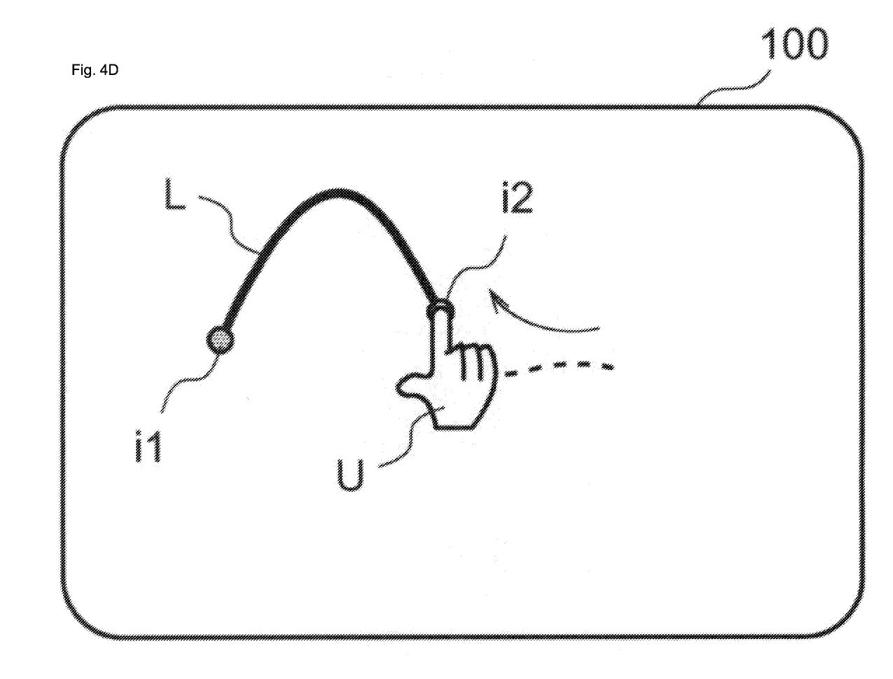

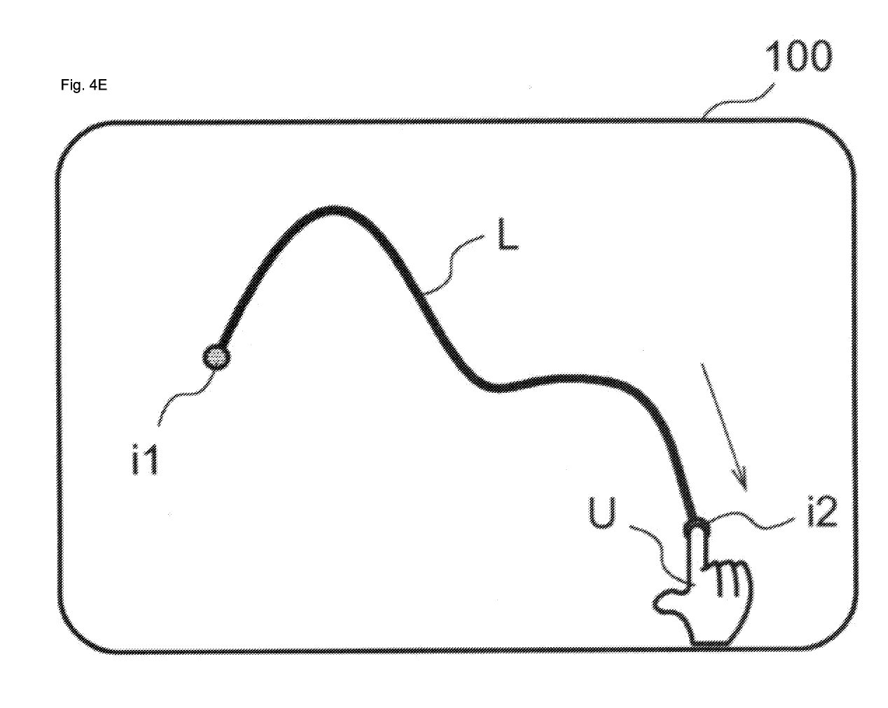

Next, an example of the editing method (drawing method) of the freehand line L on the tablet terminal 1 will be described in detail. Note that in the following, input operations (user input) are preferably performed by touch input, such as the user touching or tracing over the display screen 100 of the touch panel 10. FIG. 3 is a flowchart for describing a method for extending or partially erasing a freehand line. Moreover, FIGS. 4A to 4E show display screens 100 during the process of editing the freehand line L. FIG. 4A is a display screen of a freehand line that has been drawn. FIG. 4B is a display screen when the freehand line is selected in a first preferred embodiment of the present invention. FIG. 4C is a display screen when an indicator is selected in the first preferred embodiment of the present invention. FIG. 4D is a display screen when the freehand line is partially erased. FIG. 4E is a display screen when the freehand line is extended.

First, when the icon for drawing (not shown), for example, is selected by touch input, the drawing application (drawing program) is started (step S101). Then, when touch input of the user's finger U traces across the touch panel 10, a freehand line L is drawn (step S102). A freehand line L of a shape that corresponds to the path that is traced until the user's finger U releases is displayed on the display screen 100 as shown in FIG. 4A.

Next, when a display position of the freehand line L (which has already been displayed according to touch input of the user's finger U) is touched, this freehand line L is selected as the object of graphical editing (step S103). Then, indicators i1 and i2 are displayed at the display positions of the two endpoints EP1 and EP2 (see FIG. 4A) of the selected freehand line L as shown in FIG. 4B (step S104).

As shown in FIG. 4C, when one of the indicators, i2, is selected by touch input (YES in step S105), one of the endpoints, EP2, that corresponds to this indicator i2 is set as the starting point P0 of the extension of the freehand line L or of the portion of the line to be erased (step S106).

Next, it is determined whether or not the freehand line L is a point (step S107). If it is determined to be a point (YES in step S107), the mode selection unit 125 becomes unable to select or set up the Partial Erasure mode to erase at least a portion of the freehand line L. Then, it is determined whether or not the length of the path of the touch input that traces over the touch panel 10 equals or exceeds a first threshold W1 (step S108). If the length is determined to be less than the first threshold W1 (NO in step S108), then it is determined whether or not touch input has finished (for example, whether or not the user's finger U has lifted from the touch panel 10) (step S109). If it is determined that the touch input has not finished (NO in step S109), the user's touch input is determined to be continuing, and the process returns to step S108. When it is determined that touch input has finished (YES in step S109), editing of the freehand line L is determined to have finished, and the process terminates.

If it is determined that the first threshold W1 has been equaled or exceeded (YES in step S108), the Extend mode is set so as to extend the freehand line L from its starting point P0 (the endpoint EP2 set in step S106) (step S110). Then, the freehand line L is extended from its starting point P0 according to the shape and length of the path of the user's touch input (step S111). It is then determined whether or not touch input has finished (for example, whether or not the user's finger U has lifted from the touch panel 10) (step S112). If it is determined that the touch input has not finished (NO in step S112), the user's touch input is determined to be continuing, and the process returns to step S111. When the touch input is determined to have finished (YES in step S112), the extension of the freehand line L is confirmed. In other words, the freehand line L, after the Extend mode processing, is joined to a portion newly extended from the starting point P0 (the endpoint EP2 selected in step S106) and becomes a new, single freehand line. Processing then terminates.

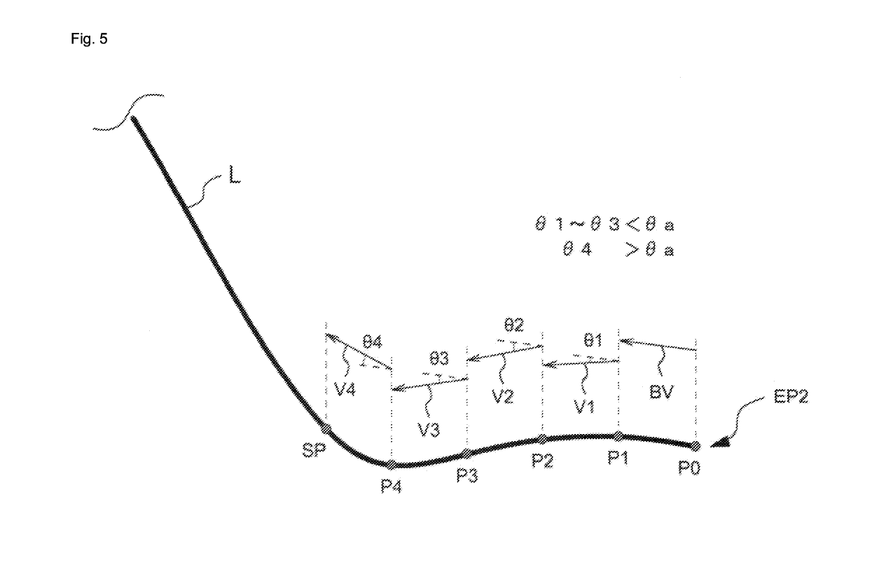

Alternatively, if it is determined in step S107 that the freehand line L is not a point (NO in step S107), then the line vector (and particularly its direction) of the freehand line L in the vicinity of the starting point P0 is determined. Note that the method for calculating the line vector will be described in detail later with reference to FIG. 5. First, it is determined whether or not the length of the freehand line L along the shape is equal to or greater than a predetermined second threshold W2 (e.g., about 5.0 mm) on the display screen 100 (step S113).

If it is determined to be less than the second threshold value W2 (NO in step 113), the line vector in the space between the two endpoints EP1 and EP2 of the freehand line L is calculated (step S114). Specifically, this makes the entire freehand line L the portion in the vicinity of the starting point P0. Processing then proceeds to step S118.

Meanwhile, if the length is determined to be at least the second threshold W2 (YES in step S113), it is determined whether or not there is any sharp change in the direction in the freehand line L within the portion that is within the second threshold W2 from the starting point P0 along the freehand line L (step S115). For example, as will be described later, the portion that is within the second threshold W2 is divided into a plurality of sectors, and it is determined whether or not the partial vector of each of the sectors changes more acutely than a predetermined first angle threshold θa (e.g., about ±15°) compared to a base vector BV (see FIG. 5 to be described later).

If it is determined that the change is more acute than the first angle threshold θa (YES in step S115), the line vector in the portion from the starting point P0 to a point that does not generate an acute change is calculated (step S116). For instance, the vector average is calculated based on the base vector BV and the partial vectors up to the sector where partial vector change does not exceed the first angle threshold θa. Then, the calculated vector average is set as the line vector of the freehand line L in the vicinity of the starting point P0 (see FIG. 5 to be described later). Processing then proceeds to step S118.

Meanwhile, if it is determined that the change is not more acute than the first angle threshold θa (NO in step S115), then the line vector in the portion within the second threshold W2 from the starting point P0 along the freehand line L is calculated (step S117). For example, the vector average is calculated based on the base vector BV and the partial vectors of the respective sectors. The calculated vector average is set as the line vector of the freehand line L in the vicinity of the starting point P0. Processing then proceeds to step S118.

Next, it is determined in step S118 whether or not the length of the path of the touch input that traces over the touch panel 10 equals or exceeds the first threshold W1. If the length is determined to be less than the first threshold W1 (NO in step S118), then it is determined whether or not the touch input has finished (for example, whether or not the user's finger U has lifted from the touch panel 10) (step S119). If it is determined that the touch input has not finished (NO in step S119), the user's touch input is determined to be continuing, and the process returns to step S118. When the touch input is determined to have finished (YES in step S119), it is determined that editing of the freehand line L has finished, and the process terminates.

Meanwhile, if it is determined that a distance of the first threshold W1 or more was moved (YES in step S118), the user vector (direction of movement) of the path traced by touch input is calculated (step S120). Note that the user vector of the path can be calculated in a similar fashion to, for example, steps S114 through S117 (and FIG. 5 to be described later). Then, it is determined whether or not the user vector of the touch input path differs from the line vector in the vicinity of the starting point P0 of the freehand line L by more than a second angle threshold θb (e.g., ±15°) (step S121).

If it is determined that the difference is not more than the second angle threshold θb (NO in step S121), Partial Erasure mode is set (step S122). Then, the portion from the starting point P0 which corresponds to the length of the path of the touch input of the user's finger U (the dotted line portion) is erased as shown in FIG. 4D (step S123). Next, it is determined whether or not the touch input has finished (for example, whether or not the user's finger U has lifted from the touch panel 10) (step S124). If the touch input has not finished (NO in step S124), partial erasure of the freehand line L by touch input is determined to be continuing, and the process returns to step S123. If the touch input has finished (YES in step S124), the erasure of the freehand line L is confirmed. To put it another way, the freehand line L after processing in Partial Erasure mode is the freehand line L from which the portion corresponding to the length of the touch input path along the shape of the freehand line L from the starting point P0 (the dotted line portion in FIG. 4D) has been erased. Processing then terminates.

In addition, if it is determined that the difference is more than the second angle threshold θb (YES in step S121), Extend mode is set (step S125). Then, a new freehand line according to the shape and length of the path of the touch input of the user's finger U is extended from the starting point P0 as shown in FIG. 4E (step S126). Next, it is determined whether or not the touch input has finished (for example, whether or not the user's finger U has lifted from the touch panel 10) (step S127). If the touch input has not finished (NO in step S127), the extension of the freehand line L by touch input is determined to be continuing, and the process returns to step S126. If the touch input has finished (YES in step S127), the extension of the freehand line L is confirmed. In other words, the freehand line L, after Extend mode processing, is joined to a portion newly extended from the starting point P0 (the endpoint EP2 selected in step S106) and becomes a new, single freehand line. Processing then terminates.

Next, a method for calculating line vectors and user vectors will be described using the method for calculating line vectors in the vicinity of the starting point P0 of the freehand line L as an example. Note that this calculation method can also be used when calculating user vectors of the paths of touch input tracing over the touch panel 10 as described above. FIG. 5 is a diagram for illustrating one example of a method for finding line vectors in the vicinity of the starting point of a freehand line. Note that the endpoint EP2 on the right side of the freehand line L (see FIG. 4A) is set as the starting point P0 in FIG. 5.

As shown in FIG. 5, a plurality of control points P1 through P4 aligned at specified intervals are set up on the freehand line L in the portion of the freehand line L from the starting point P0 to a threshold point SP located at a position separated from the starting point by a distance equivalent to the second threshold W2 along the shape of the freehand line L. Note that while the four control points P1 through P4 preferably are set up in FIG. 5, with regard to the control points for finding the line vector of the freehand line L, it is sufficient if at least two control points are set up include the starting point P0 and the threshold point SP, for example. Note also that the starting point P0, the respective control points P1 through P4, and the threshold point SP are preferably set at equal intervals along the freehand line L in FIG. 5, but these intervals may differ from each other, for example.

Next, the base vector BV and first through fourth partial vectors V1 through V4 in the respective sectors will be determined. The base vector BV is a vector that goes from the starting point P0 toward the control point P1 aligned adjacent thereto. Furthermore, each of the first through fourth partial vectors V1 through V4 is a vector that goes from a point on the side closer to the starting point P0 toward a point on the far side in each sector. For example, the first partial vector V1 goes from the control point P1 toward the control point P2, the second partial vector V2 goes from the control point P2 toward the control point P3, and the third partial vector V3 goes from the control point P3 toward the control point P4. Moreover, the fourth partial vector V4 goes from the control point P4 toward the threshold point SP.

The directions of the first through fourth partial vectors V1 through V4 are compared to the direction of the base vector BV in order starting from the first partial vector V1. In addition, the vector average is determined from the first partial vector V1 through the partial vector whose angular change of direction relative to the base vector BV is less than the first angle threshold θa. Then, the vector average is set as the line vector of the freehand line L in the vicinity of the starting point P0. For example, in FIG. 5, the amounts of change θ1 through θ3 in the direction (angle) of the first through third partial vectors V1 through V3 relative to the base vector BV are less than the first angle threshold θa, but the amount of change θ4 in the direction (angle) of the fourth partial vector is larger than the first angle threshold θa. For this reason, the vector average that is determined from the base vector BV and the first through third partial vectors V1 through V3 is set as the line vector of the freehand line L in the vicinity of the starting point P0. Note that unlike FIG. 5, if the amounts of change θ1 through θ4 in the direction (angle) of the first through fourth partial vectors V1 through V4 are less than the first angle threshold θa, then the vector average is determined from the base vector BV and the first through fourth partial vectors V1 through V4.

The first preferred embodiment was described above. The tablet terminal 1 of the first preferred embodiment preferably includes the input detection unit 10b, the user vector calculating unit 123, the line vector calculating unit 124, and the display control unit 126. The input detection unit 10b accepts touch input. The user vector calculating unit 123 calculates a user vector whose starting point P0 is either endpoint EP1 or endpoint EP2 of the freehand line L displayed on the liquid crystal display 10a of the touch panel 10 based on the touch input. The line vector calculating unit 124 calculates a line vector whose starting point P0 is either endpoint EP1 or endpoint EP2 based on the shape of the freehand line L in the vicinity of the endpoint EP1 or endpoint EP2. Based on the user vector and line vector, the display control unit 126 determines whether to extend or to erase at least a portion of the freehand line L, with either the endpoint EP1 or endpoint EP2 being taken as the starting point P0. Furthermore, the display control unit 126 extends or erases at least a portion of the freehand line L based on (the path of) the touch input.

Moreover, a drawing method used in the tablet terminal of the first preferred embodiment includes a user vector calculation step, a line vector calculation step, a determination step, and an extension or partial erasure step. In the user vector calculation step, a user vector whose starting point P0 is either endpoint EP1 or endpoint EP2 of the freehand line L displayed on the liquid crystal display 10a of the touch panel 10 is calculated based on the touch input. In the line vector calculation step, a line vector whose starting point P0 is either the endpoint EP1 or endpoint EP2 is calculated based on the shape of the freehand line L in the vicinity of the endpoint EP1 or endpoint EP2. In the determination step, whether to extend or to at least partially erase the freehand line L, with either the endpoint EP1 or endpoint EP2 being taken as the starting point P0, is determined based on the user vector and line vector. In the extension or partial erasure step, the freehand line L is extended or at least partially erased based on the path of the touch input.

In addition, a drawing program that runs on the tablet terminal 1 of the first preferred embodiment causes the CPU 12 to execute the user vector calculation step, the line vector calculation step, the determination step, and the extension or partial erasure step. In the user vector calculation step, a user vector whose starting point P0 is either endpoint EP1 or endpoint EP2 of the freehand line L displayed on the liquid crystal display 10a of the touch panel 10 is calculated based on the touch input. In the line vector calculation step, a line vector whose starting point P0 is either the endpoint EP1 or endpoint EP2 is calculated based on the shape of the freehand line L in the vicinity of the endpoint EP1 or endpoint EP2. In the determination step, whether to extend or to at least partially erase the freehand line L, with either the endpoint EP1 or endpoint EP2 being taken as the starting point P0, is determined based on the user vector and line vector. In the extension or partial erasure step, the freehand line L is extended or at least partially erased based on the path of the touch input.

As a result, whether to extend or to at least partially erase the freehand line L, with either the endpoint EP1 or endpoint EP2 of the freehand line L being taken as the starting point P0, is determined by using the user vector based on the touch input and the line vector based on the shape of the freehand line L in the vicinity of the endpoint EP1 or EP2. Furthermore, the freehand line L is either extended or at least partially erased based on (the path of) the touch input when the user vector is calculated. For this reason, when the freehand line L is to be extended or at least partially erased, there is no need for new touch input for selecting one of the two actions. Accordingly, even if there are drawing errors such as gaps or jumps in the line while the freehand line L is being drawn, the freehand line L is extended or at least partially erased more intuitively and simply.

Moreover, in the tablet terminal 1 of the first preferred embodiment, the display control unit 126 preferably extends the freehand line L when the angle defined by the user vector and the line vector is larger than the predetermined second angle threshold θb. In addition, the display control unit 126 erases at least a portion of the freehand line L when the angle defined by the user vector and the line vector is less than or equal to the second angle threshold θb.

By doing this, if the direction of the user vector differs from the direction of the line vector by more than the second angle threshold θb, the freehand line L can be extended. On the other hand, if the direction of the user vector is the same as the direction of the line vector within the tolerance of the second angle threshold θb, then at least a portion of the freehand line L is erased.

### Second Preferred Embodiment

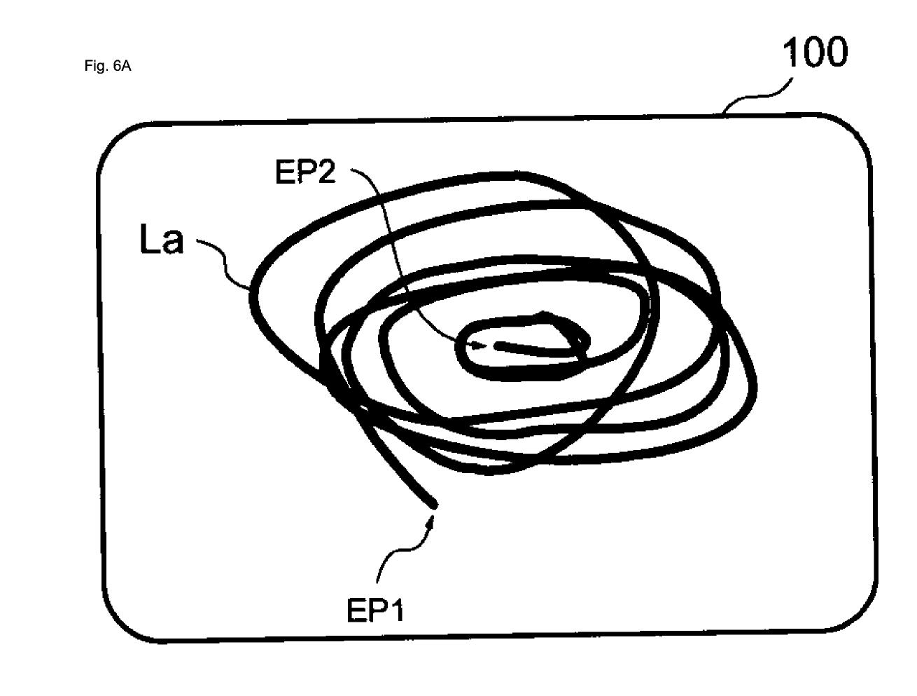

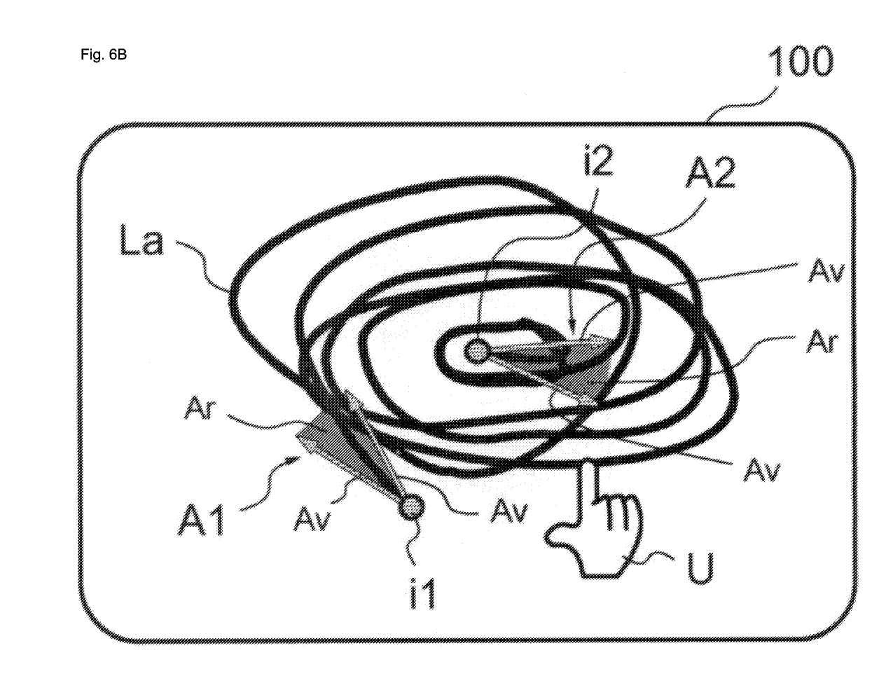

Next, a second preferred embodiment of the present invention will be described. FIG. 6A is a diagram showing one example of a freehand line that has been drawn in a complex manner. FIG. 6B is a display screen when the freehand line is selected in the second preferred embodiment.

When the freehand line La that has been drawn has a very complex shape as in FIG. 6A, it becomes difficult to determine not only the two endpoints EP1 and EP2, but also the drawing direction (for example, the line vector) in the vicinity of each of the endpoints EP1 and EP2. When the user intends to edit (partially erase or extend) such a freehand line La, it is very difficult to know in which direction the selected indicator i1 or i2 needs to be moved to be able to make the desired edit. For example, when the user intends to erase a portion of the freehand line La, if the user vector of the touch input path differs from the line vector in the vicinity of one of the endpoints EP1 and EP2 by more than the second angle threshold θb, then the freehand line La will be extended, contrary to the user's intentions.

In order to prevent such an unintended edit, in the second preferred embodiment, when the freehand line La to be edited is selected, guide displays A1 and A2 are displayed in addition to the indicators i1 and i2 over the two endpoints EP1 and EP2 as shown in FIG. 6B. Everything else preferably is the same or substantially the same as in the first preferred embodiment. Note that those items which are different from the first preferred embodiment will be described below. Furthermore, constituent components that are the same as in the first preferred embodiment are given the same symbols, and the description thereof may be omitted.

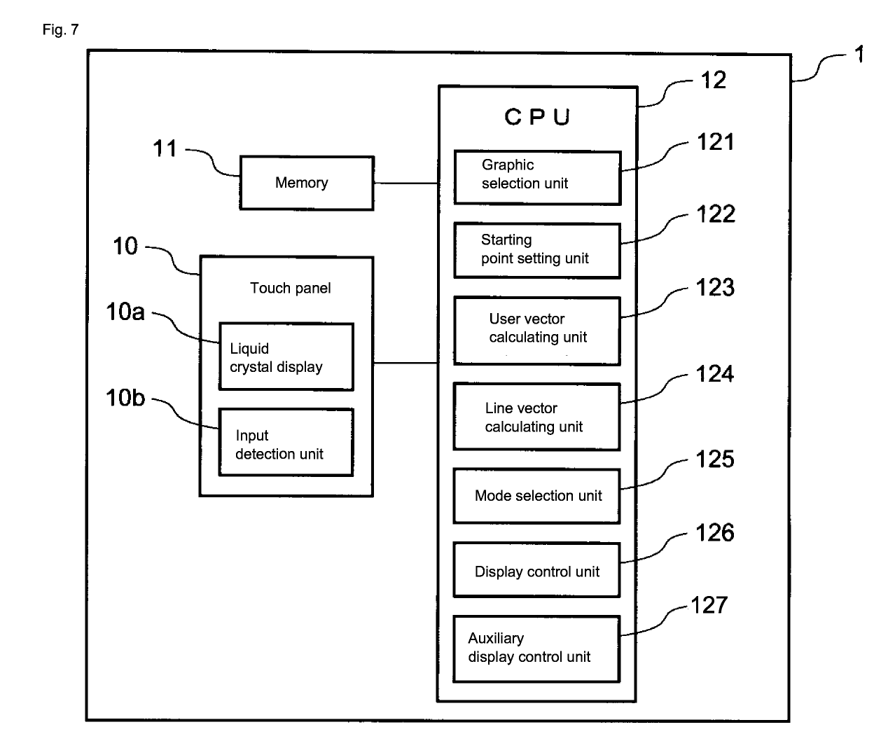

FIG. 7 is a block diagram showing the internal configuration of the tablet terminal 1 according to the second preferred embodiment. As shown in FIG. 7, the functional elements of the CPU 12 of the tablet terminal 1 are configured and programmed so as to further include an auxiliary display control unit 127 that causes the guide displays A1 and A2 to be displayed on the touch panel 10. These guide displays A1 and A2 are auxiliary displays that show vector directions used to erase at least a portion of the freehand line La, with either the endpoint EP1 or endpoint EP2 being taken as the starting point P0. If the user vector direction is within the guide display, the Partial Erasure mode is set up. Such guide displays A1 and A2 as shown in FIG. 6B makes it possible for the user to visually recognize in which direction to move the touch input in order to be able to set the Partial Erasure mode. These guide displays A1 and A2 are displayed with each of the endpoints EP1 and EP2 as the starting point P0 and configured so as to include two boundary vectors Av and one area display Ar.

The respective boundary vectors Av are vectors that have the same endpoint EP1 or EP2 as their starting point P0 and face directions different from each other (for example, clockwise and counterclockwise), with each heading toward a direction different from the line vector in the vicinity of the starting point P0 by the second angle threshold θb. Furthermore, the area display Ar is shown in the region between the two boundary vectors Av.

Note that there are no particular restrictions on the display of the respective boundary vectors Av and the area display Ar (size, line type, display color, etc.), and they may be set as appropriate depending on the degree of ease of visibility to the user. For instance, the size of the boundary vectors Av and the area display Ar may be determined in advance or may be determined according to the size of the freehand line La. Moreover, the type of line that indicates the boundary vectors Av may be a solid line or may be a dotted line. In addition, the display color of the boundary vectors Av and the area display Ar may be the same color as the freehand line La, but a different color is preferable, and they may be displayed with a transparent color. By doing so, the display of the boundary vectors Av and area display Ar is easily made visible to the user.

When the guide displays A1 and A2 are thus displayed on the two endpoints EP1 and EP2 of the freehand line La, the user can visually recognize in which direction to move the touch input to be able to edit the freehand line La in the desired editing mode (namely, in Extend mode or in Partial Erasure mode). Accordingly, the user can edit the freehand line La more comfortably and easily.

The second preferred embodiment was described above. The tablet terminal 1 of the second preferred embodiment preferably is further equipped with the auxiliary display control unit 127. This auxiliary display control unit 127 displays on the liquid crystal display 10a of the touch panel 10 the guide displays A1 and A2 that show vector directions to extend or at least partially erase the freehand line La with the two endpoints EP1 or EP2 being used as the starting point P0. By doing so, the vector direction to extend or at least partially erase the freehand line La is visually presented to the user.

### Third Preferred Embodiment

Next, a third preferred embodiment of the present invention will be described. In the third preferred embodiment, when the indicator i1 or i2 is selected (for example, see steps S105 and S106 in FIG. 3), the guide display A1 or A2 is displayed only on one of the endpoints, EP1 or EP2. Everything else preferably is the same as in the second preferred embodiment. Note that those items that differ from the second preferred embodiment will be described below. Furthermore, constituent components that are the same as in the second preferred embodiment are given the same symbols, and the description thereof may be omitted.

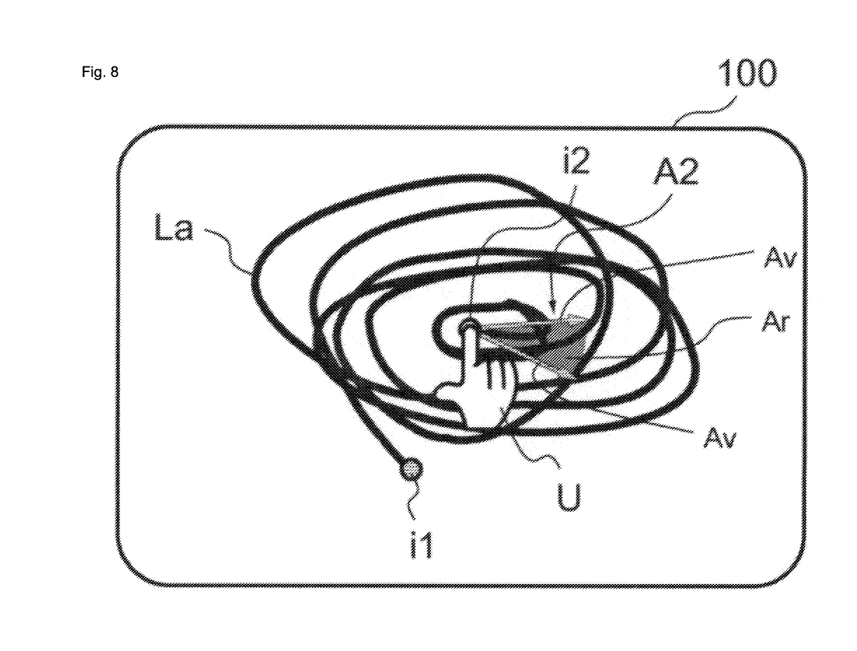

FIG. 8 is a display screen when an indicator is selected in the third preferred embodiment. For example, when the indicator i2 is selected by touch input as shown in FIG. 8, the guide display A2 is displayed only at one of the endpoints, EP2, which corresponds to the selected indicator i2. If this is done, the guide display A2 is displayed only at the endpoint EP2 that serves as the starting point P0 of the extension or partial erasure, so it is possible to edit the freehand line L while visually confirming the freehand line L in a favorable manner.

The first through third preferred embodiments of the present invention were described above. Note that the first through third preferred embodiments are shown as examples, and a person skilled in the art should understand that various modifications are possible in the combinations of the individual constituent elements and processes and that they fall within the scope of the present invention.

For instance, in the first through third preferred embodiments, the graphic selection unit 121, the starting point setting unit 122, the user vector calculating unit 123, the line vector calculating unit 124, the mode selection unit 125, the display control unit 126, and the auxiliary display control unit 127 preferably are functional components of the CPU 12 (one example of a computer), for example. However, the applicable scope of the present invention is not limited to this example. These may also be realized by a physical constituent component that is different from the CPU 12 (e.g., electrical circuitry or the like). Moreover, at least one of these elements may also be an independent constituent component.

In addition, the freehand line L preferably was edited (extended or at least partially erased) in the first through third preferred embodiments, but the present invention can also be applied when straight lines are edited.

Furthermore, in the first through third preferred embodiments, when it was determined that touch input had finished, the shape of the freehand line L was fixed, and this editing (partial erasure or extension) process terminated (for example, see steps S112, S119, S124, and S127 in FIG. 3). It would also be possible for the tablet terminal 1 to include a cancellation function (a so-called “undo function”) that returns the edited freehand line L to its pre-edited state after this editing process has terminated. This sort of function can be realized, for example, by displaying a symbol (so-called “undo icon”) for running the cancellation function on the display screen 100 of the touch panel 10. Doing so would enable the freehand line L to be returned to its pre-edited state by the cancellation function even if the editing of the freehand line L results in something that the user did not intend due to user operating error, misjudgment of the direction of the user vector or line vector, or the like. Accordingly, the freehand line L could be edited again.

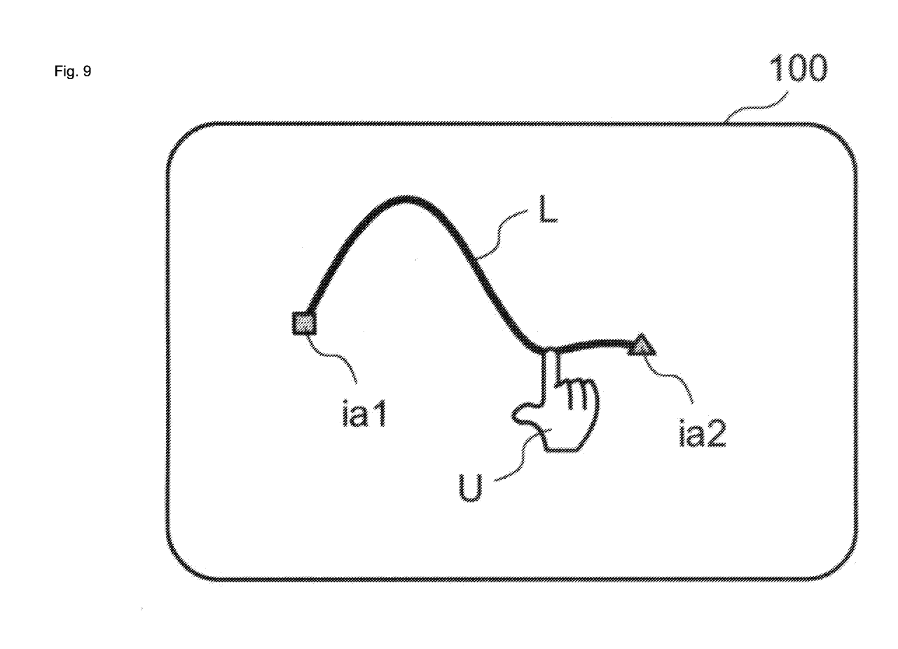

Moreover, in the first through third preferred embodiments, the specifications were the same for the indicators i1 and i2 displayed on the two endpoints EP1 and EP2 of the freehand line L, but their specifications may also differ. FIG. 9 is a diagram showing another display example of indicators. The shapes of the indicators ia1 and ia2 displayed on the respective endpoints EP1 and EP2 may differ from each other as shown in FIG. 9. Furthermore, there are no restrictions on the type of their shapes. For example, the indicators ia1 and ia2 may be polygons including triangles, quadrilaterals, and hexagons, rounded shapes including circles and ellipses, cross shapes, star shapes, or the like. In addition, the display colors, size, and the like of the indicators ia1 and ia2 displayed on the respective endpoints EP1 and EP2 may also differ from each other.

In the first through third preferred embodiments, furthermore, line vectors in the direction from the starting point P0 toward the threshold point SP (see FIG. 5) at each endpoint EP1 or EP2 were preferably determined. However, the direction of the line vectors may conversely be from the threshold point SP toward the starting point P0. In this case, if it is determined that the user vector differs from the line vector by at least the second angle threshold θb (e.g., about ±15° in step S121 of FIG. 3, for example, then the Partial Erasure mode may be set. Moreover, if it is determined to not differ by the second angle threshold θb or more, then the Extend mode may be set.

In addition, in the second and third preferred embodiments, the guide displays A1 and A2 preferably indicated the range in which the Partial Erasure mode can be set (see FIGS. 6B and 8), but they may conversely indicate the range in which the Extend mode can be set. Doing this makes it possible for the user to easily recognize visually in which direction to move the touch input in order to be able to set the Extend mode.

Furthermore, in the second and third preferred embodiments, the guide displays A1 and A2 included both two boundary vectors Av and a single area display Ar, but the applicable scope of the present invention is not limited to this example. The guide display A may be configured so as to include only the two boundary vectors Av or only the area display Ar. By doing this, the freehand line La may be made more easily visible to the user when the guide displays A1 and A2 are being displayed.

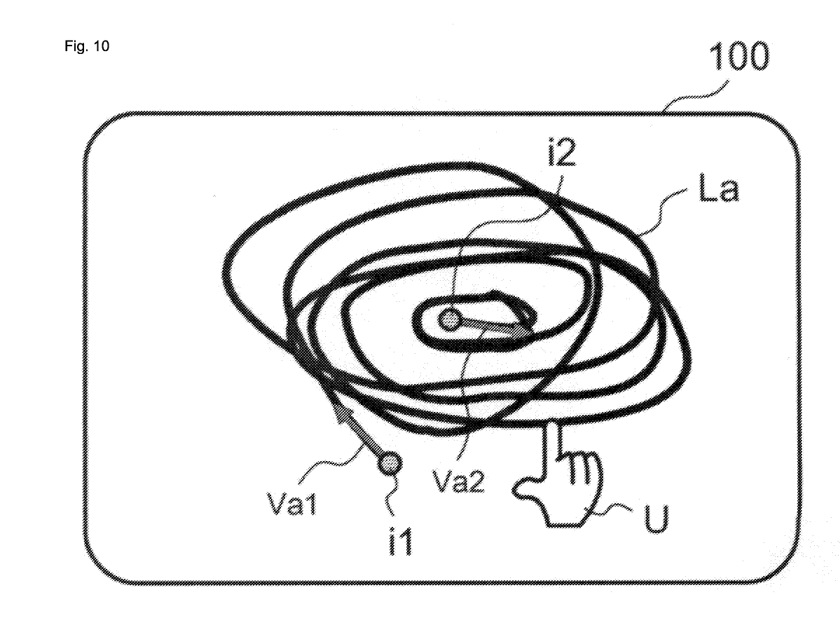

Alternatively, the guide displays A1 and A2 may use a constitution that differs from FIGS. 6B and 8. FIG. 10 is a diagram showing another display example of guide displays. Line vectors Va1 and Va2 in the vicinity of the two endpoints EP1 and EP2 may be displayed at the two endpoints EP1 and EP2 as guide displays A1 and A2 as shown in FIG. 10. If this is done, the guide displays A1 and A2 are displayed even more easily. Moreover, the line vector Va1 or Va2 in the vicinity of one of the endpoints EP1 and EP2 may be displayed at only the endpoint EP1 or EP2 that corresponds to the indicator it or i2 that has been selected by touch input. By doing so, the guide displays A1 and A2 are displayed even more easily.

In addition, in the first through third preferred embodiments, the tablet terminal 1 including the touch panel 10 was described as an example, but the applicable scope of the present invention is not limited to this example. Various preferred embodiments of the present invention can be applied widely to electronic devices having drawing applications, such as smartphones, personal computers, and PDAs. Furthermore, various preferred embodiments of the present invention can also be applied to information processing equipment in which a display device such as a liquid crystal display instead of the touch panel 10 and input devices such as a keyboard and a mouse are provided or connected.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A drawing device comprising:
an input unit configured to accept user input;
a first vector calculation unit configured to calculate a first vector including a starting point that is an endpoint of a hand-drawn line displayed on a display unit based on the user input;
a second vector calculation unit configured to calculate a second vector including a starting point that is the endpoint based on a shape of the hand-drawn line near the endpoint; and
a display control unit configured and programmed to determine whether to extend the hand-drawn line or to erase at least a portion of the hand-drawn line with the endpoint as the starting point based on the first and second vectors and to perform extension or at least partial erasure of the hand-drawn line based on the user input.

2. The drawing device according to claim 1, wherein
the display control unit is configured and programmed to extend the hand-drawn line if an angle defined by the first and second vectors exceeds a predetermined threshold; and
the display control unit is configured and programmed to erase at least a portion of the hand-drawn line if the angle defined by the first and second vectors is equal to or less than the predetermined threshold.

3. The drawing device according to claim 1, further comprising an auxiliary display control unit configured and programmed to display, on the display unit, an auxiliary display that indicates a vector direction for extending or erasing at least a portion of the hand-drawn line with the endpoint as the starting point.

4. A drawing method comprising:
a step of calculating a first vector including a starting point that is an endpoint of a hand-drawn line displayed on a display unit based on user input;
a step of calculating a second vector including a starting point that is the endpoint based on a shape of the hand-drawn line near the endpoint;
a step of determining whether to extend the hand-drawn line or to erase at least a portion of the hand-drawn line with the endpoint as the starting point based on the first and second vectors; and
a step of performing extension or at least partial erasure of the hand-drawn line based on the user input.

5. A non-transitory computer-readable medium including a computer drawing program which executes, when the program runs on a computer, a method comprising:
a step of calculating a first vector including a starting point that is an endpoint of a hand-drawn line displayed on a display unit based on user input;
a step of calculating a second vector including a starting point that is the endpoint based on a shape of the hand-drawn line near the endpoint;
a step of determining whether to extend the hand-drawn line or to erase at least a portion of the hand-drawn line with the endpoint as the starting point based on the first and second vectors; and
a step of performing extension or at least partial erasure of the hand-drawn line based on the user input.
